(19) United States
(12) Patent Application Publication
(10) Pub. No.: US 2013/0145220 A1
(43) Pub. Date: Jun. 6, 2013

(54) Detection on Resource Leakage

(71) Applicant: Peng LV, Nanjing (CN)

(72) Inventor: Peng LV, Nanjing (CN)

(73) Assignee: TELEFONAKTIEBOLAGET L M ERICSSON (PUBL), Stockholm (SE)

(21) Appl. No.: 13/814,045

(22) PCT Filed: Mar. 15, 2011
(86) PCT No.: PCT/CN2011/000407

§ 371 Date: Feb. 4, 2013

(51) Int. Cl. G06F 11/30

(52) U.S. Cl. CPC G06F 11/3065
USPC 714/47.1

(57) ABSTRACT

A method for detecting a resource leakage in a computing system is disclosed. The method comprises steps of: obtaining (S210, S320) a usage concerning a resource in the computing system, which represents one of samples in a time series; determining (S220, S330) whether the samples tend to increase; and reporting (S230, S340) occurrence of the resource leakage in the computing system if it is determined that the samples tend to increase. An arrangement (600) for detecting a resource leakage in a computing system is also disclosed.

### TECHNICAL FIELD

The present invention generally relates to resource management in a computing system. More specifically, and in various embodiments, the present invention relates to a method, an arrangement, a computer program product, and a computer readable medium for detecting a resource leakage in a computing system.

### BACKGROUND

A memory leak (or leakage, in this context) occurs when a computer program consumes memory but is unable to release it back to the operating system. It can diminish the performance of the computer by reducing the amount of available memory. Eventually, in the worst case, too much of the available memory may become allocated and all or part of the system or device stops working, the application fails, or the system slows down unacceptably due to thrashing.

However, it is difficult to have an accurate and timely detection or prediction on memory leaks, especially in a large-scale system, such as telecom software, partially because there will not usually be an immediate symptom when a leakage begins.

A variety of methods and technologies have been developed to address the memory leakage issue. For example, a method has been developed in which a fixed threshold of memory usage is set, and if the peak of total memory usage exceeds the fixed threshold, it is determined that the memory is in the memory leak state. FIG. 1 shows a schematic process for detecting a memory leakage in a computer. As shown in FIG. 1, at step S110, the current memory usage of the computer is measured. Then, at step S120, if it is determined that the measured usage is greater than a predetermined threshold TH1, proceeding to step S130, where the occurrence of the leakage is reported to the operation system; otherwise, the process continues with step S140, where a predetermined interval elapses and afterwards the process returns to step S120.

The method, however, fails to consider the fact that the memory usage is usually proportional to the service load of a system, and thus in some circumstances, the prominent peak of the memory usage above the threshold does not suggest a memory leak but merely a high load. Once the load drops, the memory usage will return its normal level. Furthermore, an abrupt leakage may cause the memory exhausted in a short period and with this method, if the threshold TH1 is improperly set as a high value, there may has no sufficient time to warn in advance until the memory capacity is totally unavailable.

Another approach is to carry out a series of tests for finding potential leaks with debuggers, such as Rational Purify® available from IBM in Armonk, N.Y., U.S.A., in development phase. However, for a large-scale and complex system, it is impossible to enumerate all code branches in the tests, and thus the likelihood of leakage can only be reduced. Additionally, the debugging is a time-consuming process and will significantly extend the development course.

### SUMMARY OF THE INVENTION

It is the object to obviate at least some of the above disadvantages and provide an improved solution for detecting the resource leakage.

Aspects of the invention include a method for detecting a resource leakage in a computing system. The method may comprise the following steps: obtaining a usage concerning a resource in the computing system, which represents one of samples in a time series; determining whether the samples tend to increase; and reporting occurrence of the resource leakage in the computing system if it is determined that the samples tend to increase.

In a preferred embodiment according to the present invention, in the determining step, if there exists a set of ascending samples in the time series, it is determined that the samples tend to increase. More preferably, in the determining step, the set of ascending samples is characterized as follows:

(S₁, . . . ,Sᵢ,Sᵢ₊₁, . . . ,Sₖ),Sᵢ₊₁>Sᵢ,1≦i≦k−1

Sᵢ=mₓ,Sᵢ₊₁=m_{y},x<y

where k is the number of elements in the set of the ascending samples, Sᵢ is the i^{th} element in the set of the ascending samples, mₓ and m_{y} are the x^{th} and the y^{th} samples in the time series.

In another preferred embodiment according to the present invention, the samples are obtained by measuring the usage periodically.

In another preferred embodiment according to the present invention, the resource is memory or file descriptors available for the whole computing system, an application or a process.

Another aspects of the present invention includes an arrangement for detecting a resource leakage in a computing system. The arrangement comprises: a first unit for obtaining a usage concerning a resource in the computing system, which represents one of samples in a time series; a second unit for determining whether the samples obtained by the first unit tend to increase; and a third unit for reporting occurrence of the resource leakage in the computing system if the second unit determines that the samples tend to increase.

There also provides a computer program product adapted to carry out the method as described above when run on a computer and a computer readable medium comprising computer executable program code adapted to carry out the steps in the method as described above.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views.

FIG. 1 shows a schematic process for detecting a memory leakage in a computer.

FIG. 2 is a flowchart illustrating method steps for memory leakage detection according to one exemplary embodiment of the present invention.

FIG. 3 is a flowchart illustrating method steps for memory leakage detection according to one exemplary embodiment of the present invention.

FIG. 4 is a flowchart illustrating an exemplary algorithm for searching for the set of the ascending samples from the time series.

FIG. 5 shows a simulation diagram obtained by means of the algorithm of FIG. 4.

FIG. 6 is a block diagram illustrating one embodiment of an arrangement for detecting a memory leakage according to the present invention.

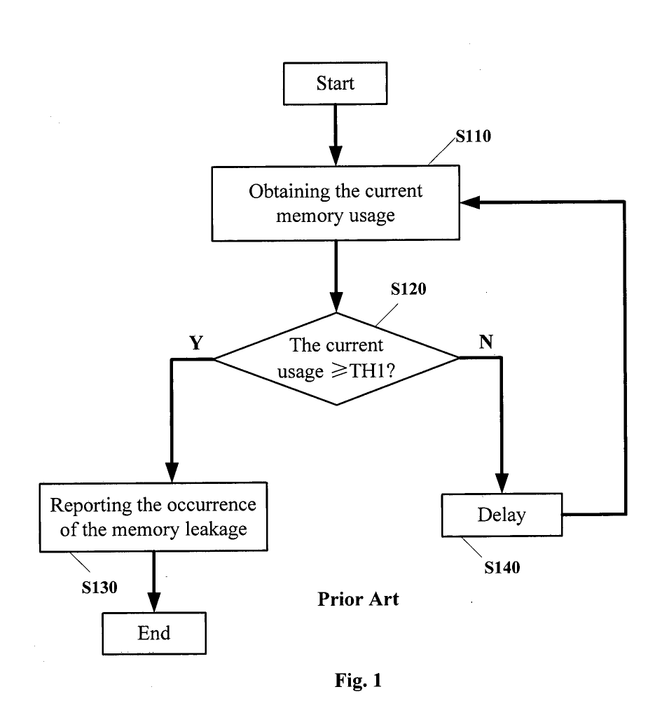

### DETAILED DESCRIPTION

While the invention covers various modifications and alternative constructions, embodiments of the invention are shown in the drawings and will hereinafter be described in detail. However it should be understood that the specific description and drawings are not intended to limit the invention to the specific forms disclosed. On the contrary, it is intended that the scope of the claimed invention includes all modifications and alternative constructions thereof falling within the scope of the invention as expressed in the appended claims.

Unless defined in the context of the present description, otherwise, all technical and scientific terms used herein have the same meaning as commonly understood by one of ordinary skill in the art to which this invention belongs.

Moreover, by way of a non-limiting example, the methods and arrangements of the present invention are illustrated by being used in the memory leakage scenario. However, it should be understood that the present invention can be applied to other kinds of resources, which are limited in terms of their amounts or usage and cannot be reused partially or completely due to errors or faults. For example, one kind of the resources can be file descriptors, which are assigned to each process or task in a UNIX-like operation system and if not properly released, the process will suffer core-dump consequently. Other kinds of such resources include but are not limited to computing capability and communication channels.

According to one embodiment of the present invention, resource usage is periodically or randomly monitored on whether it has a trend to increase or rises steadily, and if such trend exists, it is determined that a resource leakage occurs. This approach may exclude the situation that a peak of the resource usage merely results from a high load during operation.

Note that in the present invention, a variety of methods and arrangements can be used to efficiently and effectively “probe” the trend to increase or the steady increase, which will be described in detail.

The methods and arrangement, as shown in the following drawings, can be used in a variety of computing system, e.g., including but not limited to server, personal computer, laptop computer, embedded computer and like. Moreover, the methods can be implemented in form of software, hardware, firmware or the combination thereof.

For illustrative purpose, the following embodiments are assumed to be applied to a computing system comprising a processor, a memory, I/O device(s), an operation system, and application(s). The computing system further comprises an arrangement for detecting memory leakage. Although the following embodiments according to the present invention are described in conjunction with the computing system having the above structure, it is not intended to limit the present invention to any specific system.

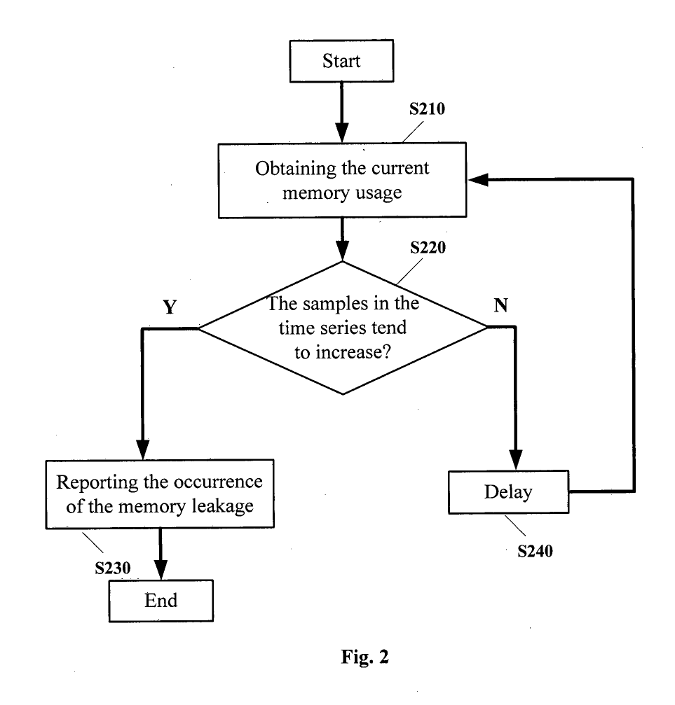

FIG. 2 is a flowchart illustrating method steps for memory leakage detection according to one exemplary embodiment of the present invention.

Referring to FIG. 2, at step 210, the arrangement measures or obtains the current memory usage of the computing system. The current value, together with the values previously measured, constitute a time series. In other words, each of the values can be regarded as one of samples in the time series. Note that the word “measure” herein means that the measuring is performed by either the arrangement itself or other components external to the arrangement, e.g., the underlying functionality or routine provided by the operation system and invoked by the arrangement.

Then, the process proceeds to step S220, where the arrangement determines whether there is a steady rising among the samples of the time series, i.e., whether the samples tend to increase. If such rising is found, the process proceeds to step S230; otherwise, the process proceeds to step S240.

At step S230, the arrangement generates a message indicating that a memory leakage occurs and transmits it to the operation system so that appropriate actions will be taken to prohibit the performance of the computing system from being degraded.

On the other hand, at step 240, the arrangement waits for a predetermined interval and then returns to step S210. With this interval, the samples of the time series are measured or obtained periodically. However, the fixed interval is unnecessarily and indeed, measuring may occur randomly. For example, the arrangement may be configured to initiate a leakage detection process in response to the receipt of a trigger signal, e.g., from the operation system.

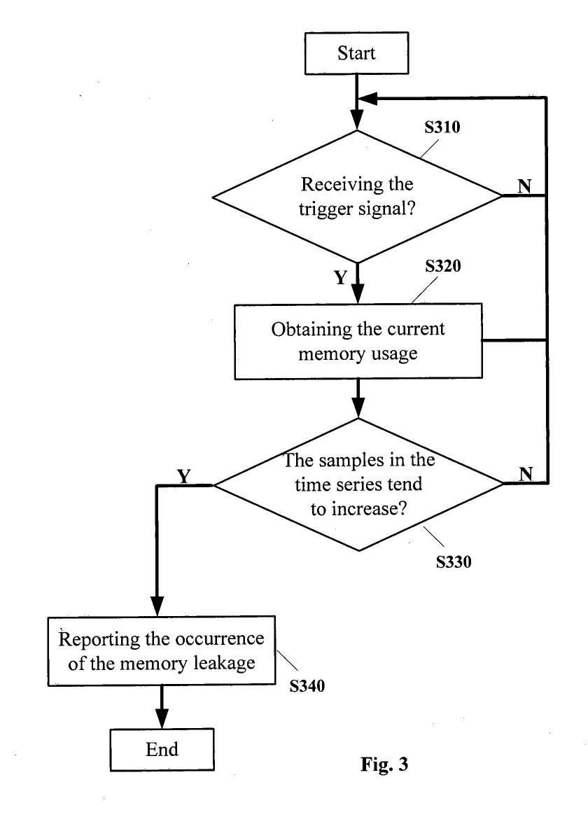

FIG. 3 is a flowchart illustrating method steps for memory leakage detection according to one exemplary embodiment of the present invention.

Referring to FIG. 3, at step 310, the arrangement “listen for” the trigger signal or command from the operation system. If receiving the signal, the process proceeds to step S320; otherwise, the arrangement continues to listen for the signal or command.

At step 320, the arrangement measures or obtains the current memory usage of the computing system to form a time series consisting of the current value and the history values.

Then, the process proceeds to step S330, where the arrangement determines whether the samples of the time series tends to increase. If such trend is found, the process proceeds to step S340; otherwise, the process proceeds to step S310.

At step S340, the arrangement generates a message that a memory leakage occurs and transmits the message to the operation system, which, in turn, takes appropriate actions.

Note that in the above embodiments, the memory usage refers to that of the whole computing system. However, the embodiments as shown in FIGS. 2 and 3 can also be applied to the case where the memory usage of an executing program or a task needs to be monitored. These variation and modification are within the spirit and principle of the present invention.

Now explains how to determine whether the samples of the time series tend to increase or rise, i.e., whether there exists a steady increase or a trend to increase among the samples of the time series.

Assuming that the memory usage is periodically measured with the interval T, whereby generating a time series denoted as (m₁, m₂, m₃, . . . mₙ, . . . ), herein, where mₙ represents the sample measured at the n^{th} time-point. According to one embodiment of the present invention, the trend or the steady increase is characterized by the following set of ascending samples:

(S₁, . . . ,Sᵢ,Sᵢ₊₁, . . . ,Sₖ),Sᵢ₊₁>Sᵢ,1≦i≦k−1 (1)

Sᵢ=mₓ,Sᵢ₊₁=m_{y},x<y (2)

where k is the number of elements in the set of the ascending samples, Sᵢ is the i^{th} element in the set of the ascending samples, mₓ and m_{y} are the x^{th} and the y^{th} samples in the time series.

In other words, if from the time series (m₁, m₂, m₃, . . . mₙ, . . . ), one can find out a plurality of samples (e.g., k elements in this embodiment) ascending in time, it is determined that there exists a trend to increase or a steady increase. Visually, a set of the ascending samples under the conditions (1) and (2) appears as a number of “valleys” which are raised with time, though the samples may fluctuate.

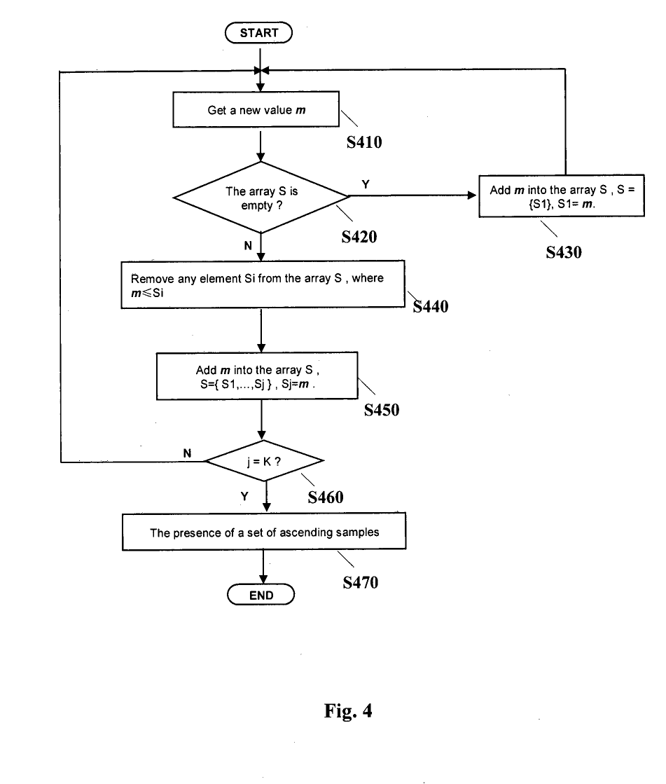

FIG. 4 is a flowchart illustrating an exemplary algorithm for searching for the set of the ascending samples from the time series.

Referring to FIG. 4, at step S410, a new value for the memory usage, denoted as m herein, is obtained as the current value. As noted above, the value can be periodically or randomly measured.

Then, at step S420, if it is determined that the array for the ascending samples, denoted as S herein, is empty, the procedure proceeds to step S430, where the current value m is recorded as the first element S₁ in the array S, and further to step S410; otherwise, proceeding to step S440.

At step S440, any element being not less than the current value m is removed from the array S. Subsequently, at step S450, the current value is recorded as the tail or last element of the array S, denoted as Sⱼ herein.

Then, the process proceeds to step 460 to determine whether the number of the elements in the array S is equal to a predetermined parameter k, i.e., whether there exists a set of ascending samples in the time series. If it is the case, the process proceeds to step S470, where the event of the steady rising is reported; otherwise, returning step S410.

Below is an illustrative C pseudo-code segment for implementing the algorithm of FIG. 4.

1 static int S[k] ; /* define an array with k elements */
2
3 while(1) /* Loop to measure memory usage periodically */
4 {
5 get the current memory usage “m”;
6
7 for (int j = 0; j < k; j++) {
8 if (S[j]==0) {
9 S[j]=m;
10 break;
11 } else if( m <= S[j] ) {
12 S[j]=m;
13 set S[j+1]..S[k−1] as zero;
14 break;
15 }
16 }
17 if ( j== k−1 ) {
18 /*
19 * The pattern is found. All elements in array S[ ] are non-zero.
20 * And S[i+1]>S[i]. It means continuous increase in memory usage,
21 * indicating there could be memory leak problem!
22 * Stop looping and exit the algorithm.
23 */
24 return 1;
25 }
26
27 delay( Delta_t ); /* delay delta_t interval to measure memory usage */
28 }

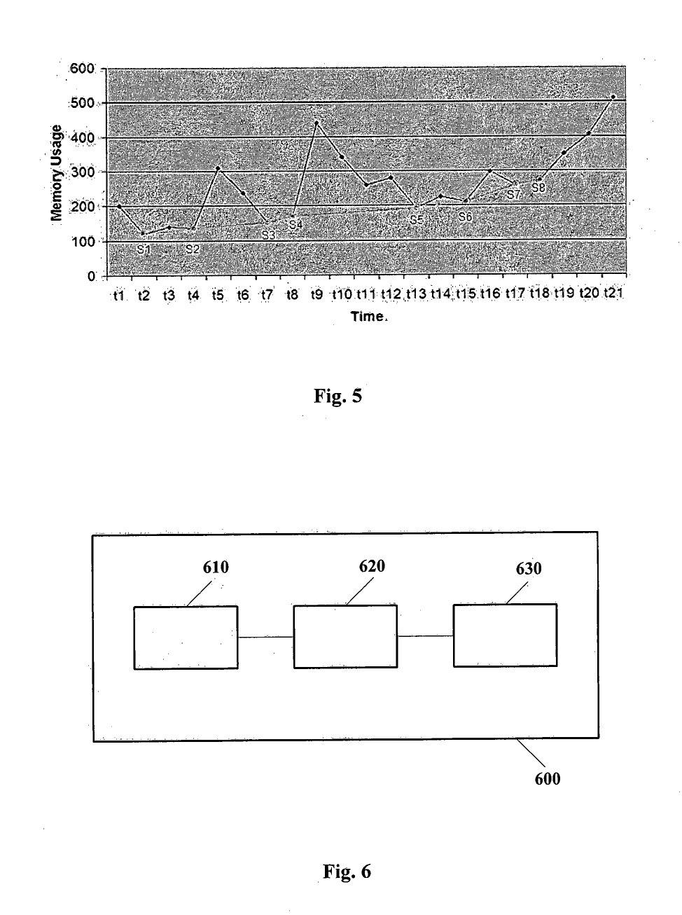

FIG. 5 shows a simulation diagram obtained by means of the algorithm of FIG. 4. As seen from FIG. 5, the memory usage is periodically measured at the timings t1, t2, t3, . . . , t21, . . . , with a fixed interval T therebetween. At the timing t18, the procedure has detected a set of ascending samples:

(S₁, . . . ,Sᵢ,Sᵢ₊₁, . . . ,Sₖ),Sᵢ₊₁>Sᵢ,1≦i≦k−1

Following the timing t18, the memory usage increases abruptly, causing a crash in the system under simulation test. If the procedure functions as a detector for memory leakage, the crash can be avoided.

Still referring to FIG. 5, although the memory usage presents a prompt increase between the timings t8 and t9, it drops at the subsequent timings t10 and t11 due to the decreased load. With the above algorithm, this false signal will be well recognized and thus ignored.

In the example, the number of the samples k is set as 8. It should be noted that this parameter, along with the interval ΔT can be adjusted to adapt to a variety of occasions. For example, it is considerable to adopt ΔT having a greater value for a slow memory leak and ΔT having a smaller value for a quick memory leak. As for the number of the samples k, it is found that the greater k will improve detection accuracy and reliability but may need more time.

As described above, the trend to increase in the time series can be detected by searching for the set of ascending samples therein. In another embodiment which will be described in detail, an algorithm based on moving-average (MA) is used.

Still assuming that the memory usage is periodically measured with the interval ΔT, whereby generating a time series denoted as (m₁, m₂, m₃, . . . mₙ, . . . ) herein. According to the embodiment, the trend or the steady increase is determined based on the change of the moving average of the time series. In particular, if the moving average is greater than a predetermined threshold, it is determined that the time series has a steady increase; otherwise, no steady increase occurs. Alternatively, the moving average may be replaced by its changing rate.

While obtaining a new measurement for the memory usage, e.g., the n^{th} sample in the time series, the moving average of the time series MA can be updated as follows:

$$M A = \frac{{\sum }_{i = n - h + 1}^{n} {m}_{i}}{h} \qquad ( 3 )$$

where mᵢ is the i^{th} sample in the time series, and h is the number of the samples for averaging.

Note that the number of the samples and the threshold are adjustable so as to adapt to a variety of occasions. For example, the number and the threshold at a lower level will result in a prompt response to the memory leakage but risk a false detection. On the other hand, with a higher level for these parameters, accuracy and reliability are anticipated but sensitivity decreases.

FIG. 6 is a block diagram illustrating one embodiment of an arrangement for detecting a memory leakage according to the present invention.

The arrangement as shown in FIG. 6 may be implemented in form of a software tool for monitoring real memory usage status, which runs on or is integrated with the operating system, a circuitry for specific purpose, e.g., Application Specific Integrated Circuit (ASIC), Field Programmable Gate Array (FPGA), or the combination thereof. It can also be implemented as a standalone tool for debugging memory leak in development phase.

Referring to FIG. 6, the arrangement 600 comprises a first unit 610, a second unit 620 and a third unit 630. In case of the arrangement embodied as a software tool, the first to third units 610-630 can be implemented in form of separate component or module. The first unit 610 is responsible for obtaining or measuring a plurality of samples for the memory usage of the computing system by invoking the routine provided by the operation system. As described above, the samples constitute a time series. Again, the memory usage can be either periodically or randomly measured.

The second unit 620 communicates with the first unit 610 and the third unit 630. It determines whether the samples obtained by the first unit 610 have a trend to increase. If such trend is found, the third unit 630 will report the occurrence of the memory leakage to the operation system. In this embodiment, the second unit 620 can be configured to perform the determination by using the methods as described above.

In comparison with the conventional technology for detecting the memory leakage, the methods and arrangement herein disclosed, in conjunction with FIGS. 2, 3, 4, 5 and 6, enables an instant, accurate and reliable detection on memory leak to avoid system crash. Particularly, the memory usage peak caused by dynamic service load can be effectively filtered out.

According to one embodiment of the present invention, it provides a computer program product adapted to carry out the methods as described above when run on a computer.

According to another embodiment of the present invention, it provides a computer readable medium comprising computer executable program code adapted to carry out the steps of anyone of the methods as described above.

It should be noted that the aforesaid embodiments are illustrative of this invention instead of restricting this invention, substitute embodiments may be designed by those skilled in the art without departing from the scope of the claims enclosed. The wordings such as “include”, “including”, “comprise” and “comprising” do not exclude elements or steps which are present but not listed in the description and the claims. It also shall be noted that as used herein and in the appended claims, the singular forms “a”, “an”, and “the” include plural referents unless the context clearly dictates otherwise. This invention can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names.

1-12. (canceled)

13. A method for detecting a resource leakage in a computing system, the method comprising:
obtaining a plurality of samples in a time series, each sample representing usage concerning a resource in the computing system;
determining whether the samples tend to increase;
reporting occurrence of a resource leakage in the computing system in response to determining that the samples tend to increase.

14. The method of claim 13, wherein the determining comprises determining that the samples tend to increase if there exists a set of ascending samples in the time series.

14. The method of claim 14, wherein the set of ascending samples are characterized as (Sᵢ, . . . , Sᵢ, Sᵢ₊₁, . . . , Sₖ), where:
Sᵢ₊₁>Sᵢ;
1≦i≦k−1
Sᵢ=mₓ,Sᵢ₊₁=m_{y},x<y;
k is the number of elements in the set of the ascending samples;
Sᵢ is the i^{th} element in the set of the ascending samples;
mₓ and m_{y} are the x^{th} and the y^{th} samples in the time series.

16. The method of claim 13, wherein the samples are periodic.

17. The method of claim 13, wherein the resource is memory available for an application, a process, or the whole computing system.

18. The method of claim 13, wherein the resource is file descriptors available for an application, a process, or the whole computing system.

19. An arrangement for detecting a resource leakage in a computing system, comprising:
a first unit configured to obtain a plurality of samples in a time series, each sample representing usage concerning a resource in the computing system;
a second unit configured to determine whether the samples obtained by the first unit tend to increase;
a third unit configured to report occurrence of a resource leakage in the computing system in response to determining that the samples tend to increase.

20. The arrangement of claim 19, wherein the second unit is configured to determine the samples tend to increase if there exists a set of ascending samples in the time series.

21. The arrangement of claim 20, wherein the set of ascending samples are characterized as (Sᵢ, . . . , Sᵢ, Sᵢ₊₁, . . . , Sₖ), where:
Sᵢ₊₁>Sᵢ;
1≦i≦k−1
Sᵢ=mₓ,Sᵢ₊₁=m_{y},x<y;
k is the number of elements in the set of the ascending samples;
Sᵢ is the i^{th} element in the set of the ascending samples;
mₓ and m_{y} are the x^{th} and the y^{th} samples in the time series.

22. The arrangement of claim 21, wherein the first unit is configured to obtain the samples by measuring the usage periodically.

23. The arrangement of claim 19, wherein the resource is memory available for an application, a process, or the whole computing system.

24. The arrangement of claim 19, wherein the resource is file descriptors available for an application, a process, or the whole computing system.

25. A computer program product stored in a non-transitory computer readable medium for detecting a resource leakage in a computing system, the computer program product comprising software instructions which, when run on a computer, causes the computer to:
obtain a plurality of samples in a time series, each sample representing usage concerning a resource in the computing system;
determine whether the samples tend to increase;
report occurrence of a resource leakage in the computing system in response to determining that the samples tend to increase.
